(19) United States
(12) Patent Application Publication
(10) Pub. No.: US 2013/0204508 A1
(43) Pub. Date: Aug. 8, 2013

(54) SYSTEM AND METHOD FOR CONTROLLING AN ENGINE

(71) Applicants: Christopher Whitt, Howell, MI (US); Douglas Christopher Sarsen, Howell, MI (US); Christopher C. Swoish, Lapeer, MI (US)

(72) Inventors: Christopher Whitt, Howell, MI (US); Douglas Christopher Sarsen, Howell, MI (US); Christopher C. Swoish, Lapeer, MI (US)

(73) Assignee: GM Global Technology Operations LLC, Detroit, MI (US)

(21) Appl. No.: 13/368,452

(22) Filed: Feb. 8, 2012

(51) Int. Cl. F02D 28/00; F01N 11/00

(52) U.S. Cl. 701/102

(57) ABSTRACT

A method for controlling regeneration within an after-treatment component of an engine comprises receiving an upstream temperature signal representing a temperature of an exhaust stream upstream from the after-treatment component and calculating an expected downstream temperature based on the upstream temperature signal and a model for calculating the expected downstream temperature. A temperature index is calculated based on the upstream temperature signal and the expected downstream temperature, and an estimate of accumulated particulate matter in the after-treatment component is calculated based, at least in part, on the temperature index. The estimate of accumulated particulate matter in the after-treatment component is compared to a predetermined threshold associated with the after-treatment component, and a remedial action is initiated when the estimate of accumulated particulate matter in the after-treatment component exceeds the predetermined threshold.

### FIELD OF THE INVENTION

The subject invention relates to engine controls and more particularly to a system and method for controlling regeneration within an after-treatment component of a compression-ignition engine.

### BACKGROUND

Controllers for modern vehicle engines rely upon an extensive array of instrumentation to provide feedback to enable control over the many aspects of engine operation. This is due, in part, to increased complexity in modern engines and demands imposed on engines from multiple simultaneous constraints. For example, demands for improved engine economy imposes one set of constraints on engine designs while demands for sufficient power output imposes another set of sometimes inconsistent constraints while emission limitations impose yet another set of constraints. The use of instrumentation to measure pressures, temperatures, and flow rates at various locations within an engine, and the use of an engine controller with a microprocessor, enable an engine to meet such competing design and operating constraints.

As an example of increasing regulation that imposes constraints on engine operation, the emission of particulate matter in exhaust from compression-ignition engines is regulated for environmental reasons. To help meet such regulations, vehicles equipped with compression-ignition engines often include after-treatment components such as particulate filters, catalyzed soot filters and adsorption catalysts for removing particulate matter and other regulated constituents (e.g., nitrogen oxides or NOx) from their exhaust streams. Particulate filters and other after-treatment components can be effective, but can also increase back pressure as they collect particulate matter.

Particulate matter may include ash and unburned carbon particles generally referred to as soot. As this carbon-based particulate matter accumulates in the after-treatment components, it can increase back pressure in the exhaust system. Engines that have large rates of particulate mass emission can develop excessive back pressure levels in a relatively short period of time, decreasing engine efficiency and power producing capacity. Therefore, it is desired to have particulate filtration systems that minimize back-pressure while effectively capturing particulate matter in the exhaust.

To accomplish both of these competing goals, after-treatment components must be regularly monitored and maintained either by replacing components or by removing the accumulated soot. Through a combination of instrumentation, simulation modeling, and control methodologies, after-treatment components can be effectively monitored and maintained. For example, when a controller deems it appropriate, accumulated soot can be cleaned from an after-treatment component via regeneration (i.e., oxidation to CO2, burning-off). To avoid service interruptions, regeneration is generally preferred over replacement of after-treatment components. Thus, it is desirable to have an effective system and method for controlling regeneration processes. Fortunately, engine control systems can be used to predict when it may be advantageous to actively facilitate a regeneration event and to effectuate control over the regeneration process.

An engine control system may use a soot model to deduce (i.e., predict) a mass of soot accumulated in the after-treatment component by monitoring properties of the exhaust stream as it flows through the after-treatment component. The control system can use the deduced soot mass data to monitor soot loading over time, to determine or anticipate when regeneration may be necessary or desirable, to facilitate a regeneration event, and/or to effectuate control over a regeneration process or other remedial measures. In one exemplary soot model, the pressure decrease across a loaded after-treatment component may be used, along with knowledge of the relationship between soot accumulation and pressure decrease, to estimate the extent of soot loading in the after-treatment component. This is possible because, as soot accumulates in an after-treatment component, the pressure decrease typically increases (at specific temperature and volumetric flow rates) from pressure decreases experienced when the after-treatment component is clean.

Because changes in temperature, pressure, and flow rate affect the pressure decrease experienced by exhaust as it passes through an after-treatment component, the accuracy and reliability of measurements for these parameters is important. Ideal gas laws may also be used to adjust flow rates for changing temperatures and pressures, further adding to the importance of accurate determinations for these parameters. Unfortunately, however, a number of difficulties have been encountered determining temperatures and pressures in and around after-treatment components. For example, experience has shown that exhaust gas temperatures can deviate significantly from material temperatures in an after-treatment component, particularly during non-steady, or transient, operation. This is due to significant thermal inertias that may exist in typical after-treatment components, which can be accompanied by correspondingly large temperature gradients as the components respond to transient operating conditions. Therefore, as a result of the large dependency on an accurate temperature measurement, errors can be caused by temperature gradients occurring in after-treatment components.

Accordingly, it is desirable to provide an improved system and method for evaluating the reliability of control parameters and for replacing values that are determined to be erroneous with reasonable values. It would also be desirable to provide an improved system and method for more reliably determining when to facilitate active regeneration and for controlling active regeneration of particulate filtration systems, particularly having improved model accuracy in the presence of large temperature gradients occurring in and around after-treatment components.

### SUMMARY OF THE INVENTION

In one exemplary embodiment of the invention, a method for controlling regeneration within an after-treatment component of an engine comprises receiving an upstream temperature signal representing a temperature of an exhaust stream upstream from the after-treatment component and calculating an expected downstream temperature based on the upstream temperature signal and a model for calculating the expected downstream temperature. A temperature index is calculated based on the upstream temperature signal and the expected downstream temperature, and an estimate of accumulated particulate matter in the after-treatment component is calculated based, at least in part, on the temperature index. The estimate of accumulated particulate matter in the after-treatment component is compared to a predetermined threshold associated with the after-treatment component, and a remedial action is initiated when the estimate of accumulated particulate matter in the after-treatment component exceeds the predetermined threshold.

In another exemplary embodiment of the invention, a system for controlling regeneration within an after-treatment component of an engine comprises a controller having a processor coupled to a memory storage device. The controller is configured to receive an upstream temperature signal representing a temperature of an exhaust stream upstream from the after-treatment component and calculate an expected downstream temperature based on the upstream temperature signal and a model for calculating the expected downstream temperature. The controller is also configured to calculate a temperature index based on the upstream temperature signal and the expected downstream temperature and to calculate an estimate of accumulated particulate matter in the after-treatment component based, at least in part, on the temperature index. The controller is also configured to compare the estimate of accumulated particulate matter in the after-treatment component to a predetermined threshold associated with the after-treatment component and to initiate a remedial action when the estimate of accumulated particulate matter in the after-treatment component exceeds the predetermined threshold.

The above features and advantages and other features and advantages of the invention are readily apparent from the following detailed description of the invention when taken in connection with the accompanying drawings.

### BRIEF DESCRIPTION OF THE DRAWINGS

Other features, advantages and details appear, by way of example only, in the following detailed description of embodiments, the detailed description referring to the drawings in which:

FIG. 1 is a schematic diagram showing an exemplary system for controlling regeneration within an after-treatment component of a compression-ignition engine;

FIG. 2 is a process flow diagram showing an exemplary process for controlling regeneration within an after-treatment component of a compression-ignition engine; and

FIG. 3 shows an exemplary smoothed curve corresponding to a polynomial function for a represented parameter.

### DESCRIPTION OF THE EMBODIMENTS

The following description is merely exemplary in nature and is not intended to limit the present disclosure, its application or uses. It should be understood that throughout the drawings, corresponding reference numerals indicate like or corresponding parts and features.

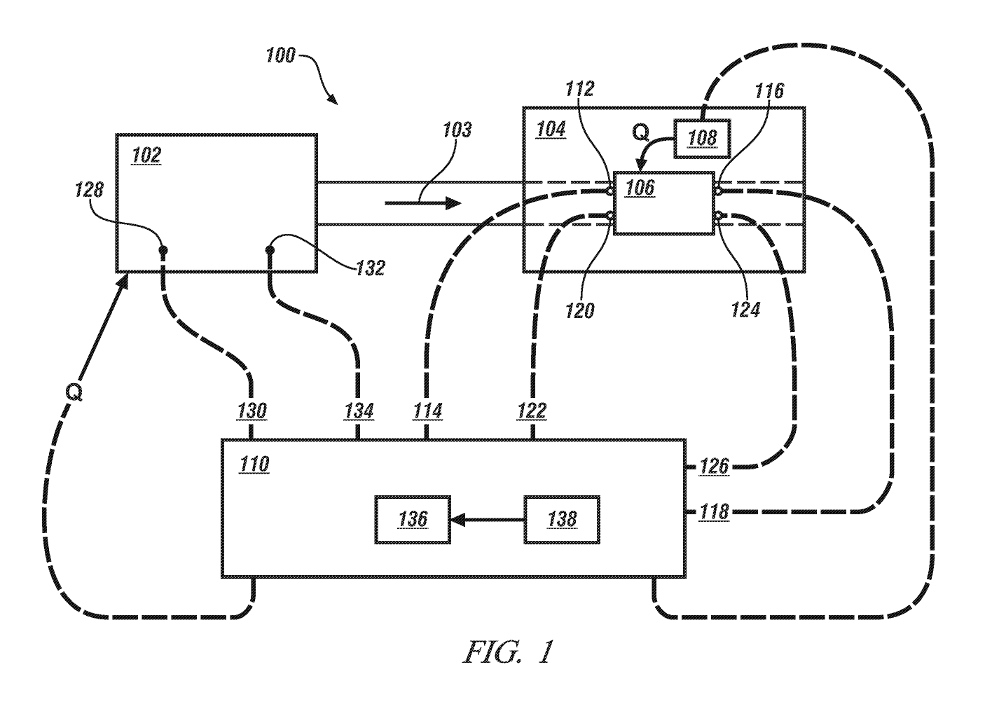

In accordance with an exemplary embodiment of the invention, as shown in FIG. 1, an exemplary system 100 for controlling regeneration within an after-treatment component of a compression-ignition engine includes a compression-ignition engine 102 coupled to an exhaust system 104, through which exhaust 103 from engine 102 passes and is treated before being discharged to the atmosphere. Exhaust system 104 includes at least one after-treatment component 106 such as a particulate filter for removing particulate matter and other regulated constituents from the exhaust stream 103. A heater 108 is configured for adding heat to the after-treatment component 106 to induce regeneration in the after-treatment component 106. A controller 110 is configured to predict when it may be necessary or advantageous to undergo regeneration in the after-treatment component and, when appropriate, to actively facilitate a regeneration event. The controller 110 may facilitate such an event, for example, by introducing heat to the after-treatment component 106 from an outside source such as the heater 108 or by causing injection of fuel into the engine 102 or the exhaust system 104.

To enable the controller 110 to better perform its functions, various instruments are positioned within the engine 102 and the exhaust system 104. The instruments are configured to be responsive to changes in relevant parameters in the engine 102 and the exhaust system 104 and to transmit signals to the controller 110 with the signals being indicative of operation of the engine 102 and the after-treatment component 104. For example, in an exemplary embodiment, an upstream pressure sensor 112 measures pressures of the exhaust stream 103 upstream from the after-treatment component 106 and produces upstream pressure signals 114. Similarly, a downstream pressure sensor 116 measures pressures of the exhaust stream 103 downstream from the after-treatment component 106 and produces downstream pressure signals 118. In addition, an upstream temperature sensor 120 measures temperatures of the exhaust stream upstream from the after-treatment component 106 and produces upstream temperature signals 122. A downstream temperature sensor 124 measures temperatures of the exhaust stream downstream from the after-treatment component 106 and produces downstream temperature signals 126. An engine speed sensor 128 senses speeds of the engine 102 and produces engine speed signals 130. An engine flow sensor 132 senses mass flow rates of working fluid (e.g., air or air and fuel or exhaust gas) flowing in the engine 102 or exhaust system 104 and produces engine flow rate signals 134.

The controller 110 receives information, such as one or more of the upstream pressure signals 114, downstream pressure signals 118, upstream temperature signals 122, downstream temperature signals 126, engine speed signals 130, and engine flow rate signals 134 from the upstream pressure sensor 112, the downstream pressure sensor 116, the upstream temperature sensor 120, the downstream temperature sensor 124, the engine speed sensor 128, and the engine flow sensor 132. A processor 136 of the controller 110 cooperates with a memory 138 associated with the controller 110 to execute instructions that are configured to enable the controller 110 to monitor and/or determine, among other things, soot loading in the after-treatment component 106. By making these determinations and/or by tracking such parameters, the controller 110 may be better able to determine or anticipate when regeneration in the after-treatment component 106 may be necessary or desirable, or may be better able to facilitate a regeneration event in the after-treatment component 106, and/or to effectuate control over a regeneration process or other remedial measures.

For example, in an exemplary embodiment, a controller 110 is configured to estimate a quantity of particulate matter accumulation in the after-treatment component 106 based on a pressure decrease index that is indicative of a decrease in pressure of the exhaust stream 103 as it passes through the after-treatment component 106. In an exemplary embodiment, the controller 110 uses the upstream pressure signals 114 and the downstream pressure signals 118 to compute the pressure decrease index. In addition, the controller 110 uses the engine flow rate signals 134 or the engine speed signals from the engine speed sensor 128 or the engine flow sensor 132 to generate a flow rate index. Still further, the controller 110 uses the upstream temperature signals 122 and the downstream temperature signals 126 to compute a temperature index indicative of a temperature of the exhaust stream 103 or of a change in temperature of the exhaust stream as it passes through the after-treatment component 106.

In situations where one or more of the temperature signals (e.g., one of the upstream temperature signals 122 and the downstream temperature signals 126) do not exist or are deemed unreliable, or in situations where greater detail in terms of temperatures within the after-treatment component 106 may be desired, a simulation model may be used to estimate one or more temperatures at one or more locations within the after-treatment component based on other known temperatures. Then, based on the additional temperature detail, a more accurate temperature index may be generated.

Similarly, in situations where one or more of the pressure signals (e.g., one of the upstream pressure signals 114 and the downstream pressure signals 118) do not exist or are deemed unreliable, or in situations where greater detail in terms of pressures within the after-treatment component 106 may be desired, a simulation model may be used to estimate one or more temperatures at one or more locations within the after-treatment component based on other known temperatures. Then, based on the additional pressure detail, a more accurate pressure index may be generated.

In an exemplary embodiment, a model is a system or method for predicting an output based on one or more inputs. For example, a model representing a temperature at a particular location in an after-treatment component may comprise a system or method for determining the temperature at that location based, for example, on a temperature measured at an upstream location, such as upstream temperature signals 122 and a flow rate such as engine flow rate signals 134. In some embodiments, observed data values for the represented temperature (i.e., the independent variable) may be tabulated versus corresponding values for the dependent variables. For example, where there are eight values for the upstream temperature signals 122 at each of four values of the engine flow rate signals 134, there may be thirty-two corresponding values for the represented temperature. Thus, a tabular interpolation method may be used to determine the value of the represented temperature at a particular combination of upstream temperature and engine flow rate. As one skilled in the art will appreciate, greater quantities of data points tends to decrease the spacing between data points, thereby decreasing the potential for errors due to the interpolation.

Unfortunately, measurement tolerances and naturally occurring variation can result in deviation of such data points away from (i.e., above or below) a set of generally smooth and continuous curves corresponding to the physical relationship. For example, while a relationship between a represented temperature and an upstream temperature may be expected to yield a smooth, continuous curve with a positive (monotonically increasing) slope, individual measurements for the represented temperature may yield minor variations from the continuous curve. These minor variations can result in discontinuities on either side of the data points as well as relative maximums and minimums.

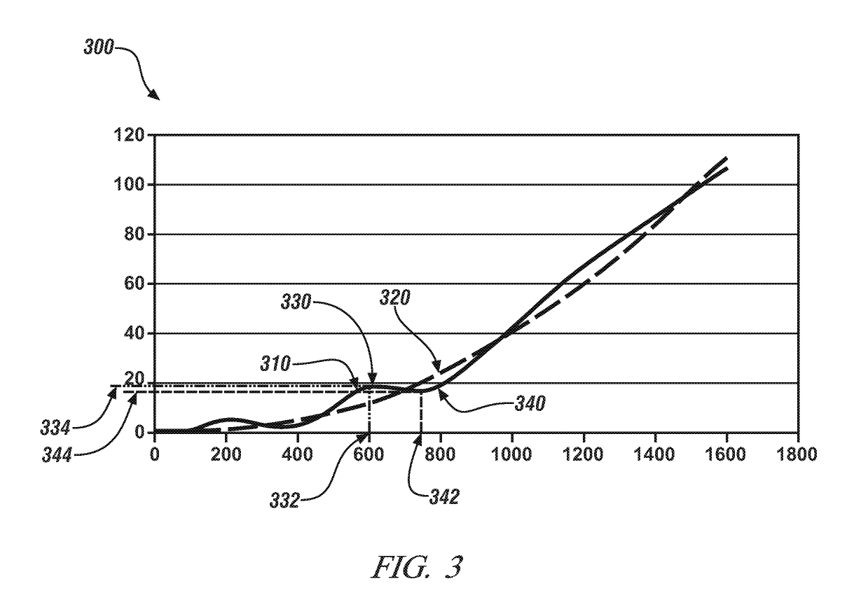

In an exemplary alternative embodiment, as shown in FIG. 3, a model 300 comprises smoothed curve 320 that corresponds to a polynomial function that is configured to closely match observed data values for a represented parameter rather than relying upon a set of tabulated values. Such a polynomial function may be characterized by a first constant added to the product of a second constant and an independent variable raised to the power of a third constant (i.e., F(x)=a+bX^{c}). To calibrate the model, the first constant, the second constant, and the third constant are adjusted until an error (i.e., data matching) criterion is satisfied. For example, the first constant, the second constant, and the third constant may be adjusted until the sum of the differences between the measured data points and the represented values calculated from the polynomial function are minimized or fall within an acceptable tolerance level. Use of a polynomial function provides a direct calculation for the represented parameter, eliminating the need for interpolation and the discontinuities that can result from interpolation between data points. In addition, a polynomial function can be represented by a relatively low number of parameters.

Curve 310 represents empirical data comprising approximately eight data points. As is commonly experienced, data values for curve 310 may fall above or below the smoothed curve 320 representing a polynomial function configured to closely match the data values, while eliminating the numerous inflection points that would be required to identically match all of the data points. While the smoothed curve fails to identically match all of the data points, it may be configured to follow a characteristic relationship supported by physics (e.g., a second order polynomial function used to characterize pressure decrease as a function of flow rate, a first order polynomial function used to characterize changes in pressure of an ideal gas as the temperature of the ideal gas also changes). In the example illustrated in FIG. 3, measured data points such as data points 330 and 340 might lead one to conclude that values of the dependent variable decreased from a value 334 to a value 344 while values of the independent variable increased from a value 332 to a value 342. Contrariwise, use of the smoothed curve 320 enables one to draw a more reasonable conclusion, namely that the model-produced value of the dependent variable increases as the value of the independent variable increases. As a result, the model produces more reasonable results even over very small increments, thereby avoiding discontinuities and irrational behavior that may be predicted using conventional interpolation techniques.

Accordingly, the use of a smoothed curve such as a polynomial function can enable a controller to model empirical data in a simple and memory-efficient manner. Use of such techniques can improve calibration of models and can facilitate addition of additional constraints (e.g., second order relationship with exponent of 2, first order relationship using exponent of 1, etc.) while enabling efficient optimization of the remaining variables such as the scale factor b and the constant adder a. The use of a polynomial expression can improve robustness of the model by eliminating unexplainable cliffs or holes that can be associated with empirical data tables and conventional interpolation techniques.

In an exemplary embodiment, a downstream pressure is represented by a polynomial function based on the upstream pressure signals 114. Also, where measured data exists for the downstream pressure (e.g., from the downstream pressure signals 118), the measured data (e.g., from the downstream pressure signals 118) can be compared against the values as computed using the polynomial function. Then, where a substantial deviation exists between the measured value (e.g., from the downstream pressure signals 118) and the calculated value, the control 110 may conclude that the measured data (e.g., from the downstream pressure signals 118) is in error and may choose to use the value calculated from the polynomial function instead.

Similarly, in an exemplary embodiment, a downstream temperature is represented by a polynomial function based on the upstream temperature signals 122. Where measured data exists for the downstream temperature (e.g., from the downstream temperature signals 126), the measured data can be compared against the values for the represented parameter as computed using the polynomial function. Then, where a substantial deviation exists between the measured value (e.g., the downstream temperature signals 126) and the calculated value, the control 110 may conclude that the measured data (e.g., the downstream temperature signals 126) is in error and may choose to use the value calculated from the polynomial function instead.

Once the properties of the flow stream 103 have been generated, the controller 110 estimates a quantity of particulate matter accumulation in the after-treatment component 106. In an exemplary embodiment, the controller 110 uses a soot accumulation model based on soot rate maps developed using engine-out conditions. In another exemplary embodiment, the controller 110 uses a soot accumulation model based on the relationship between the pressure decrease index, the flow rate index, and the temperature index. As one skilled in the art will appreciate, increases in the amount of pressure decrease (i.e., change) at a constant flow rate and temperature is indicative of accumulation of soot or other particulate matter in the after-treatment component 106. Those skilled in the art will also appreciate that the flow rate index may be normalized to a standardized temperature and a standardized pressure (e.g., according to the ideal gas law) so as to eliminate some or all of the inaccuracies associated with changes in temperature and pressure of the exhaust stream 103. This is possible because it is known that a consistent relationship may exist between pressure loss and such a corrected flow rate even though temperature and/or pressure of the flow may change.

It should be appreciated that a number of expressions exist for quantifying and tracking pressure decrease in an after-treatment component. For example, in one embodiment, the pressure decrease index is calculated as a ratio of upstream pressure to downstream pressure (i.e., PR=Pu/Pd) so as to represent a pressure ratio across the after-treatment component. In another embodiment, the pressure decrease index is calculated as a difference between the upstream pressure and the downstream pressure (i.e., DP=Pu−Pd) so as to represent a difference in pressure across the after-treatment component. In still another embodiment, the pressure decrease index is calculated as the difference between the upstream pressure and the downstream pressure, with the difference divided by the magnitude of the upstream pressure (i.e., as a normalized pressure decrease, DPP=DP/Pu) so as to represent a normalized difference in pressure across the after-treatment component. As those skilled in the art will appreciate, the above-described flow rate index signal can be produced by an engine speed sensor or a mass airflow sensor or any other sensor configured to sense an engine operating condition that is indicative of the relative flow rate of the exhaust stream 103.

When a pressure-based soot accumulation model is to be executed or relied upon for soot estimation, the controller 110 may estimate the accumulated particulate matter in the after-treatment component based, at least in part, on a soot accumulation model. As described above, the model may require knowledge of the pressures, temperatures, and flow rates of the exhaust stream 103 as described above. In an exemplary embodiment, the estimate produced by the model represents the amount of particulate matter that is predicted to have accumulated in the after-treatment component. The pressure-based soot accumulation model, which may be based on empirical data, is configured to reflect the relationship between the amount of particulate matter that has accumulated in the after-treatment component, the pressure decrease index, the flow index, and the temperature index.

Since the estimate of matter accumulated in the after-treatment component is to be compared to a predetermined threshold associated with the after-treatment component, and since a remedial action may be facilitated when the adjusted estimate of accumulated particulate matter in the after-treatment component exceeds the predetermined threshold, inaccuracies in the process would have the potential to trigger regeneration processes unnecessarily or late. Therefore, by evaluating the reliability of measured pressures and/or temperatures and, where necessary or desirable, relying upon an alternative technique for determining those temperatures and/or temperatures, such as whenever the difference between the measured value and the expected value exceeds a predetermined threshold, the controller 110 may improve reliability of the estimated level of soot accumulation, thereby reducing the need for excessive margins and potentially eliminating unnecessary service.

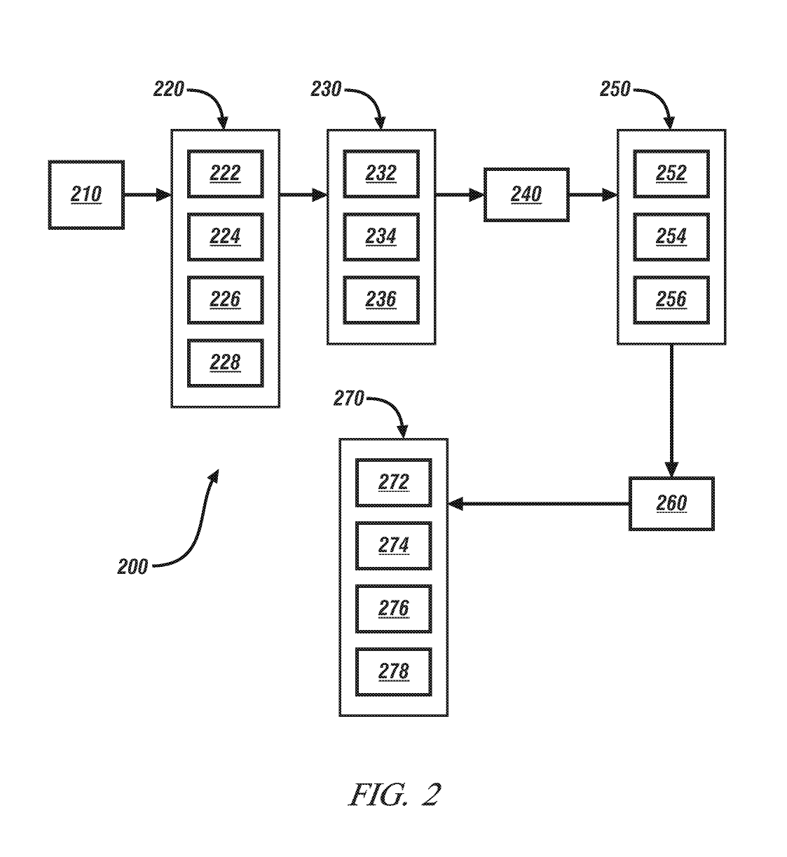

In accordance with an exemplary embodiment of the invention, as shown in FIG. 2, an exemplary process 200 for controlling regeneration within an after-treatment component of a compression-ignition engine, such as a particulate filter, generally includes the step of receiving one or more values of one or more parameters associated with an exhaust stream passing through the after-treatment component (step 210). In an exemplary embodiment, the parameter may represent upstream pressure, downstream pressure, upstream temperature, downstream temperature, engine speed, or engine flow rate. The value may be received as a signal from the upstream pressure sensor 112, the downstream pressure sensor 116, the upstream temperature sensor 120, the downstream temperature sensor 124, the engine speed sensor 128, and the engine flow sensor 132. The parameter may be a pressure decrease index indicative of a decrease in pressure of an exhaust stream as it passes through the after-treatment component, a flow rate index indicative of a rate of flow of the exhaust stream, or a temperature index indicative of a temperature of the exhaust stream 103.

In addition to receiving one or more values, the process 200 includes evaluating whether a difference between a temperature or pressure measured downstream from the after-treatment component and a corresponding expected value for that parameter exceeds a predetermined threshold (step 220). More specifically, this step of the process includes: (a) receiving an upstream temperature or pressure signal representing a temperature or pressure upstream from the after-treatment component (step 222); (b) receiving a downstream temperature or pressure signal representing a temperature or pressure downstream from the after-treatment component (step 224); (c) calculating an expected value for the downstream temperature or pressure and calculating a temperature or pressure difference between the measured downstream temperature or pressure signal and the expected value for the downstream temperature or pressure (step 226); and (d) comparing the temperature or pressure difference to a predetermined temperature or pressure difference limit to determine whether the downstream temperature or pressure signal is reliable (step 228).

When the downstream temperature or pressure signal is deemed unreliable, the controller 110 chooses to rely upon an alternative (i.e., secondary) downstream temperature or pressure estimation technique rather than using the measured value (step 230). As discussed above, in an exemplary embodiment, the controller 110 may rely upon a model using either an empirically based interpolation table or may use a polynomial function (step 232). To facilitate use of an alternative model or technique, it may be necessary for the controller 110 to acquire additional parameters (step 234). In addition, the controller 110 may disable the use of the measured pressure or temperature (step 236) so as to avoid generating or using an unreliable estimate of soot accumulation. Still further, the controller 110 may facilitate the setting and adjustment of limits on the differences between measured values and expected values, above which the measured values are not used and the alternative method is used instead (step 240).

Having acquired reliable values for temperatures and pressures, the controller 110 may rely upon a soot estimation technique, such as a soot accumulation model based on pressure decrease, to calculate an estimate of accumulated particulate matter in the after-treatment component (step 250). In one embodiment, this calculation is based, at least in part, on a soot accumulation model and the values for pressure decrease index, flow rate index, and temperature index. The estimate of accumulated particulate matter in the after-treatment component is then compared to one or more predetermined thresholds associated with the after-treatment component (step 260). A remedial action is initiated when the adjusted estimate of accumulated particulate matter in the after-treatment component exceeds the predetermined threshold (step 270).

In an exemplary embodiment, and according to a primary estimation technique, the step of estimating the quantity of accumulated particulate matter in the after-treatment component (step 250) begins with the calculation or receipt of a pressure decrease index indicative of a decrease in pressure of an exhaust stream 103 as it passes through the after-treatment component (step 252). In an exemplary embodiment, the pressure decrease index is indicative of the level of pressure decrease experienced by the exhaust stream as it passes through the after-treatment component. In one embodiment, the pressure decrease index is calculated as a ratio of upstream to downstream pressure (i.e., PR=Pu/Pd) so as to represent a pressure ratio across the after-treatment component.

In another embodiment, the pressure decrease index is calculated as a difference between the upstream and downstream pressures (i.e., DP=Pu−Pd) so as to represent a difference in pressure across the after-treatment component. In still another embodiment, the pressure decrease index is calculated as the difference between the upstream and downstream pressures divided by the magnitude of the upstream pressure (i.e., as a normalized pressure decrease, DPP=DP/Pu) so as to represent a normalized difference in pressure across the after-treatment component. An exemplary step of estimating the quantity of accumulated particulate matter in the after-treatment component (step 250) also includes determining a flow rate index that is indicative of a relative flow rate of the exhaust stream (step 254). The flow rate index signal can be produced by an engine speed sensor or a mass airflow sensor or any other sensor configured to sense an engine operating condition that is indicative of the relative flow rate of the exhaust stream 103.

Once the pressure decrease index and the flow index of the exhaust stream 103 have been determined, an exemplary step of estimating the quantity of accumulated particulate matter in the after-treatment component (step 250) employs a pressure-based soot accumulation model (step 256) to estimate the accumulated particulate matter in the after-treatment component based on the pressure decrease index and the flow rate index. As discussed above, however, when the temperature measured upstream from the after-treatment component exceeds a predetermined threshold, the controller 110 may choose to rely upon an alternative soot estimation technique rather that using a pressure-based prediction method that may be unreliable at the excessively high temperatures (step 230). As discussed above, in an exemplary embodiment, when temperatures exceed the threshold, the controller 110 relies upon a soot accumulation model that is based on soot rate maps developed based on engine-out conditions (step 232).

Regardless which technique is used, an estimate is produced representing an amount of particulate matter that is predicted to have accumulated in the after-treatment component. The pressure-based soot accumulation model, which may be based on empirical data, is configured to reflect the relationship between the amount of particulate matter that has accumulated in the after-treatment component, the pressure decrease index, and the flow index. Other techniques may reflect other relationships and may be similarly correlated to observed data.

In an exemplary embodiment, the step of initiating a remedial action (step 270) comprises adjusting one or more engine control parameters so as to modify operation of the engine to promote passive regeneration in the after-treatment component (step 272). For example, the one or more adjustments may be configured to provide a minimum temperature at the after-treatment component promoting passive regeneration in the after-treatment component. Alternatively the one or more adjustments may comprise modifying fueling and timing of the engine (step 274) or activating an auxiliary heating element to increase a temperature of the exhaust stream (step 276) or activating a warning light instructing the operator to initiate regeneration in (or replacement of) the after-treatment component (step 278).

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the application.

What is claimed is:

1. A method for controlling regeneration within an after-treatment component of an engine, comprising:
receiving an upstream temperature signal representing a temperature of an exhaust stream upstream from the after-treatment component;
calculating an expected downstream temperature based on the upstream temperature signal and a model for calculating the expected downstream temperature;
calculating a temperature index based on the upstream temperature signal and the expected downstream temperature;
calculating an estimate of accumulated particulate matter in the after-treatment component based, at least in part, on the temperature index;
comparing the estimate of accumulated particulate matter in the after-treatment component to a predetermined threshold associated with the after-treatment component; and
initiating a remedial action when the estimate of accumulated particulate matter in the after-treatment component exceeds the predetermined threshold.

2. The method of claim 1, further comprising
receiving a downstream temperature signal representing a temperature of the exhaust stream downstream from the after-treatment component;
calculating a temperature difference between the downstream temperature signal and the expected downstream temperature; and
comparing the temperature difference to a predetermined temperature difference limit to determine whether the temperature difference is less than or greater than the predetermined temperature difference limit;
wherein, if the temperature difference is less than the predetermined temperature difference limit, said calculating an estimate of accumulated particulate matter in the after-treatment component is based on the downstream temperature signal.

3. The method of claim 2, wherein, if the temperature difference is greater than the predetermined temperature difference limit, said calculating an estimate of accumulated particulate matter in the after-treatment component is based on the expected downstream temperature.

4. The method of claim 1, wherein the model for calculating the expected downstream temperature is based on a polynomial function.

5. The method of claim 4, wherein the polynomial function uses the upstream temperature signal as an independent variable.

6. The method of claim 1, further comprising:
receiving an upstream pressure signal representing a pressure of the exhaust stream upstream from the after-treatment component;
calculating an expected downstream pressure based on the upstream pressure signal and a model for calculating the expected downstream pressure;
calculating a pressure index based on the upstream pressure signal and the expected downstream pressure;
wherein said calculating an estimate of accumulated particulate matter in the after-treatment component is based, at least in part, on the pressure index.

7. The method of claim 6, further comprising:
receiving a downstream pressure signal representing a pressure of the exhaust stream downstream from the after-treatment component;
calculating a pressure difference between the downstream pressure signal and the expected downstream pressure; and
comparing the pressure difference to a predetermined pressure difference limit to determine whether the pressure difference is less than or greater than the predetermined pressure difference limit;
wherein, if the pressure difference is less than the predetermined pressure difference limit, said calculating an estimate of accumulated particulate matter in the after-treatment component is based on the downstream pressure signal.

8. The method of claim 7, wherein, if the pressure difference is greater than the predetermined pressure difference limit, said calculating an estimate of accumulated particulate matter in the after-treatment component is based on the expected downstream pressure.

9. The method of claim 6, wherein the model for calculating the expected downstream pressure is based on a polynomial function.

10. The method of claim 9, wherein the polynomial function uses the upstream pressure signal as an independent variable.

11. A system for controlling regeneration within an after-treatment component of an engine, comprising:
a controller having a processor coupled to a memory storage device, the controller being configured to:
receive an upstream temperature signal representing a temperature of an exhaust stream upstream from the after-treatment component;
calculate an expected downstream temperature based on the upstream temperature signal and a model for calculating the expected downstream temperature;
calculate a temperature index based on the upstream temperature signal and the expected downstream temperature;
calculate an estimate of accumulated particulate matter in the after-treatment component based, at least in part, on the temperature index;
compare the estimate of accumulated particulate matter in the after-treatment component to a predetermined threshold associated with the after-treatment component; and
initiate a remedial action when the estimate of accumulated particulate matter in the after-treatment component exceeds the predetermined threshold.

12. The system of claim 11, the controller being further configured to:
receive a downstream temperature signal representing a temperature of the exhaust stream downstream from the after-treatment component;
calculate a temperature difference between the downstream temperature signal and the expected downstream temperature;
compare the temperature difference to a predetermined temperature difference limit to determine whether the temperature difference is less than or greater than the predetermined temperature difference limit; and
to perform said calculating an estimate of accumulated particulate matter in the after-treatment component based on the downstream temperature signal whenever the temperature difference is less than the predetermined temperature difference limit.

13. The system of claim 12, wherein the controller is further configured to perform said calculating an estimate of accumulated particulate matter in the after-treatment component based on the expected downstream temperature whenever the temperature difference is greater than the predetermined temperature difference limit.

14. The system of claim 11, wherein the model for calculating the expected downstream temperature is based on a polynomial function.

15. The system of claim 14, wherein the polynomial function uses the upstream temperature signal as an independent variable.

16. The system of claim 11, the controller being further configured to:
receive an upstream pressure signal representing a pressure of the exhaust stream upstream from the after-treatment component;
calculate an expected downstream pressure based on the upstream pressure signal and a model for calculating the expected downstream pressure;
calculate a pressure index based on the upstream pressure signal and the expected downstream pressure; and
to perform said calculating an estimate of accumulated particulate matter in the after-treatment component based, at least in part, on the pressure index.

17. The system of claim 16, wherein the controller is further configured to:
receive a downstream pressure signal representing a pressure of the exhaust stream downstream from the after-treatment component;
calculate a pressure difference between the downstream pressure signal and the expected downstream pressure;
compare the pressure difference to a predetermined pressure difference limit to determine whether the pressure difference is less than or greater than the predetermined pressure difference limit; and
perform said calculating an estimate of accumulated particulate matter in the after-treatment component based on the downstream pressure signal whenever the pressure difference is less than the predetermined pressure difference limit.

18. The system of claim 17, wherein the controller is further configured to perform said calculating an estimate of accumulated particulate matter in the after-treatment component based on the expected downstream pressure whenever the pressure difference is greater than the predetermined pressure difference limit.

19. The system of claim 16, wherein the model for calculating the expected downstream pressure is based on a polynomial function.

20. The system of claim 19, wherein the polynomial function uses the upstream pressure signal as an independent variable.
